(19) United States
(12) Patent Application Publication
(10) Pub. No.: US 2010/0291340 A1
(43) Pub. Date: Nov. 18, 2010

(54) Method For Imparting Bleach And Stain Resistance To Dyed Yarns In Carpet And Products Made Therewith

(75) Inventor: Robert Wayne Brinkley, Adairsville, GA (US)

Correspondence Address: KILYK & BOWERSOX, P.L.L.C., 400 HOLIDAY COURT, SUITE 102, WARRENTON, VA, 20186, US

(73) Assignee: MANNINGTON MILLS, INC., Salem, NJ (US)

(21) Appl. No.: 12/771,133

(22) Filed: Apr. 30, 2010

Related U.S. Application Data
(60) Provisional application No. 61/177,355, filed on May 12, 2009.

(51) Int. Cl. B32B 33/00; D02G 3/00; B05D 3/00

(52) U.S. Cl. 428/96; 428/375; 427/372.2

(57) ABSTRACT

Methods are described for imparting bleach and stain resistance to dyed yarns, such as differentially dyed yarns, in a carpet without significant loss of color, particularly from basic dyeable color, and with reduced steaming and rinsing demands. Yarn and carpet products made by the method are also described.

This application claims the benefit under 35 U.S.C. §119(e) of prior U.S. Provisional Patent Application No. 61/177,355, filed May 12, 2009, which is incorporated in its entirety by reference herein.

### BACKGROUND OF THE INVENTION

The present invention relates to a method for imparting bleach and stain resistance to dyed yarns in a carpet and products made therewith.

Treatments have been developed to improve stain resistance of carpet fibers. Some carpet fibers can present special challenges in this respect. Differentially dyeable yarns are one such category of carpet fiber. By the term “differentially dyeable” it is meant that the yarns having at least two different dyeabilities, such as (“acid”) anionic dyeable yarn and (“cat”) cationic dyeable yarn. The “cat” dyeable yarns and “acid” dyeable yarns are each colored by the appropriate dyestuff to form “differentially dyed” yarns so that both types of yarns may contribute to the visual aesthetic properties of the carpet pile that contains the yarns. Both dyeabilities are available in various dye depths, such as light, regular, deep and extra deep acid dye and light and regular cat dye. However, difficulties can arise while stain treating carpet containing differentially dyed yarns.

For instance, nylon fiber, in hot water, will accept acid dyes naturally because the polymer chain end group is an amine (NH₂⁺). This amine group is charged positively (cationic) and is attracted to any negatively charged material such as the acid (anionic) dyestuff with a sulfonated (—SO₃⁻) end group. These two materials form simple ionic bonds when the dye material is allowed the opportunity to find the nylon end groups. Opposites attract, so the sulfonated dye becomes insoluble in water as soon as it attaches to the amine end group in the nylon. Similar to the acid dyes, many stain resistant treatments for nylon are sulfonated and are applied after the dyeing step to seal the remaining amine end groups also called dye sites. Since a typical stain blocker is usually a very large molecule and must be water soluble, the nylon must be temporarily adapted to accept the stain blocker. The technique used for many years has been to use a strong acid near pH 2 that will increase the positive charge of nylon dye sites and subsequently increase the attraction for the “sealing” stain blocker resulting in higher exhaustion rates. Other types of stain resist treatments such as acrylate dispersions and maleic acid anhydride alone or used in blends have similar functionality and incompatibility with cat dyes. In contrast to the acid dyeable nylon is the cationic (“cat”) dyeable polymer that has been modified during its polymerization to contain sulfonated end groups that are anionic in nature. This modification has been used for many years in the carpet industry to attain a completely different color if desired, dependent upon the basic (cationic) dyes used. Once again an ionic bond is formed and the dye becomes insoluble when the oppositely charged materials (nylon and dye) react with each other.

One challenging part of dyeing cationic and anionic materials simultaneously, is to keep the oppositely charged materials separated in water long enough to allow them to exhaust from the dye bath to the appropriate nylon yarns. There are very few basic (cationic) dyes that will work satisfactorily with the cationic dyeable nylon yarns without significant staining of the acid dyeable yarns too. This staining phenomenon makes the shade matching very difficult and inconsistent. In addition, the fastness of the staining is very poor especially when exposed to light. A low pH anionic stain treatment fixed by near boiling or steaming (at >100% wet add-on) can attach to the cat dyes and the resulting negative effect is a significant loss of the cat color on the nylon. This fact has been the major obstacle to attaining a commercial bleach resistant stainblocker product.

U.S. Pat. No. 6,852,134 relates to a stain resistance treatment of a differentially dyeable textile surface as part of a dyeing production line in which the stain resist application is conducted as a “hot shock” application in which the dyed textile surface of an article is passed through a bath containing bleach resistant stainblocker composition and surfactant having a temperature of 70 to 95° C. where the textile surface remains for about 5 to 30 seconds, and then treatment proceeds without steaming through adjustment of wet pick-up to preferably 200 to 600%, cooling, hydroextraction, rinsing, and drying operations.

Imparting resistance in carpet fibers to bleach discoloration is also desired. Some treatments for imparting bleach resistance have been in use since approximately the late 1990's. It has primarily been based on tannic acid chemistries. A description of tannic acid chemistry is set forth, for example, in U.S. Pat. No. 7,276,085, and reference is made thereto. Tannins perform as “bleach resist” by preventing the oxidation from occurring when a stain such as household bleach or acne medication (e.g., benzoyl peroxide) are spilled or deposited on carpeting. Tannic acid treatments can be durable, but have the disadvantage of requiring two (2) minutes or more of steaming following tannic treatment of the carpet workpiece. The extended steaming step reduces production throughput and increases production costs. Also, there is a range of molecular weights (200 to 3000) that can be made, and the best performance ideally is obtained with a wide molecular weight range that will penetrate the wide range of amorphous regions in the nylon polymer. The overall performance of tannic acid treated carpet or yarn to 100% bleach is not fully protected. With prior techniques, preservation of approximately 85% of original color through tannic treatment is all that can be ordinarily expected. The color loss becomes noticeable in carpets containing a significant amount of the differentially dyed yarns. Another disadvantage of the tannic type bleach resist is that it can yellow the overall color by approximately 5 to 15%. Normally, those that are skilled in color matching in carpet fibers can learn to adjust for this type of visual change, but it complicates the process and requires resources in order to resolve the problem.

Other bleach resist chemistries are exhausted onto nylon carpet in Beck dyeing after-treatments, which include, for example, a polymer and surfactant blend. These treatments show efficacy in resisting staining by mustard and betadine (povidone-iodine (PVPI)) type stains. Other properties include excellent durability to multiple cleaning and minimal additional color change caused by the treatment. However, these advantages have been observed in carpet fibers made only of acid dyeable nylons. This chemistry requires a pH near 2 to attain reasonable exhaustion from the water to the nylon. The amount of treatment, on a solids basis, is relatively higher than other prior types of stain treatment, while the concentration of the active agent in the aqueous medium is relatively dilute such that wet add-on to the treated carpet is high and water removal requirements are increased in order to provide target amounts, for example, of from 10 to 20% product add-on to the carpet to give the stain and bleach protection desired.

### SUMMARY OF THE INVENTION

A feature of the present invention is to provide a method for imparting bleach and/or stain resistance to differentially dyed yarns in carpet without significant loss of color. Another feature of the present invention is to provide a method for applying a bleach resistant stainblocker composition to cationic/acid differentially dyed carpet yarns in a low wet pickup, high solids add-on format and steaming the treated carpet for enhanced stainblocker fixation without rinsing being required. This provides treated carpet yarns without significant change of color.

Additional features and advantages of the present invention will be set forth in part in the description that follows, and in part will be apparent from the description, or can be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a method for treating an article having a textile surface formed of differentially dyed yarns with a bleach resistant stainblocker composition, comprising applying at least one aqueous bleach resistant stainblocker composition to the textile surface at a wet pickup of bleach resistant stainblocker composition of no greater than about 50 wt % based on the weight of the carpet face yarn being treated (also referred to herein as “based on weight of fiber” or simply “o.w.f.”) to provide a coated article; steaming the coated article to provide a steamed article; and drying the steamed article to provide a dried article, wherein the dried article comprises at least about 0.1 wt % solids add-on of the bleach resistant stainblocker composition based on the weight of the carpet face yarn being treated (o.w.f.). As an option, the bleach resistant stainblocker composition can be added to the pile in an amount effective that the treated pile surface of the carpet has a stain resistance of 8 or higher, or 9 or higher, on the AATCC Red 40 Stain Scale, and/or the treated pile surface of the carpet has a stain resistance of 2 or higher, or 3 or higher, or 4 or higher, on the AATCC Gray Scale for mustard and betadine. The treated pile surface of the carpet can have at least about 50% greater, or at least about 100% greater, retention of original color with respect to fade resistance to household bleach at 100%, 20%, and 10% concentrations thereof, as compared to an untreated carpet.

The article to be treated can be an unbacked carpet or a backed carpet, and the textile surface comprises a pile surface comprising dyed yarns, such as differentially dyed yarns. The differentially dyed yarns can comprise at least one type of yarn dyed by an acid dyestuff and/or at least one other type of yarn dyed by a cationic dyestuff. The dyed yarns can comprise nylon yarns. The application step can comprise providing a wet pick up of the bleach resistant stainblocker composition on the carpet face yarn of no more than about 50 wt %, or no more than about 25 wt %, or no more than about 20 wt %, or no more than about 15 wt %, or no more than about 10 wt % (e.g., 0.1 wt % to 50 wt %, or 1 wt % to 5 wt %), based on the weight of the carpet face yarn being treated (o.w.f.). This low wet pickup coating can be done by topically applying the bleach resistant stainblocker composition as a foam on the textile surface. The steaming step can comprise contacting the textile surface with steam under atmospheric pressure for any period of time, such as for about 1 to about 3 minutes, and the drying step can comprise drying the steamed article at any suitable drying temperature, such as at from about 225° F. to about 275° F., for a time period sufficient to provide a moisture content of about 5 wt % or less (e.g., 0.01 wt % to 5 wt % or 0.1 wt % to 3 wt %) in the carpet article. The reduced steaming and drying steps can be performed sequentially and can be free of any intermediate rinsing step. Thus, production throughput can be increased while operational costs can be reduced. A secondary backing can be formed as a single or multilayered structure, such as by coating and/or extrusions steps, on a side of the article opposite to the textile surface. The method is applicable to treatments of articles supplied as a pre-dyed continuous carpet material such as a carpet roll material, or a pre-dyed discrete piece of carpet material such as a carpet tile. Any type of carpet or any size of carpet can be treated by the present invention. Multiple treatments can be done.

The bleach resistant stainblocker composition can comprise about 25 wt % to about 85 wt % total water (moisture from all coating composition sources), and about 75 wt % to about 15 wt % total solids (all coating composition sources), wherein the solids comprise bleach resistant stainblocker and optionally an oil-water-soil-resistant fluorocarbon (based on the total wt % of the bleach resistant stainblocker composition). The bleach resistant stainblocker composition preferably can comprise 100 wt % or less, or from about 99 wt % to about 91% wt % active solids of bleach resistant stainblocker, and about 0 wt % to about 9 wt % (or 1 wt % to about 9 wt %) active solids of oil-water-soil-resistant fluorocarbon, all weight percentages based on total composition solids. The bleach resistant stainblocker composition used in the method can preferably comprise a polymer of a sulfonated triglyceride as a bleach resistant stainblocker, an anionic fluorinated urethane as a fluorocarbon, and water. The dyed yarns, such as the differentially dyed yarns, in the dried article maintain at least about 90%, or at least about 95%, of original color possessed before the applying step.

Bleach and stain resistant dyed yarns, such as differentially dyed fibers, in a carpet are provided comprising dyed yarns, such as differentially dyed fibers, and about 0.1 wt % to about 6 wt %, or about 1 wt % to about 5 wt %, solids add-on of the bleach resistant stainblocker composition, based on the weight of the carpet face yarn being treated (o.w.f.). The bleach resistant stainblocker composition preferably can comprise 100 wt % or less, or from about 99 wt % to about 91% wt % active solids bleach resistant stainblocker and about 0 wt % to about 9 wt % (or from 1 wt % to about 9 wt %) active solids oil-water-soil-resistant fluorocarbon, all weight percentages based on total composition solids. The dyed yarns can comprise at least one type of yarn dyed by an acid dyestuff and/or at least one other type of yarn dyed by a cationic dyestuff. The dyed yarns can comprise nylon yarns. A carpet can be provided that has a stain and bleach resistant pile surface comprising dyed yarns, such as differentially dyed fibers, and from about 0.1 wt % to about 6 wt %, or from about 1 wt % to about 5 wt %, solids add-on of the bleach resistant stainblocker composition, based on the weight of the carpet face yarn being treated (o.w.f.). The bleach resistant stainblocker compound preferably can be added-on the carpet face as active solids in an amount of from about 0.1 wt % to about 5 wt %, or about 1 wt % to about 4.5 wt %, or about 2 wt % to about 4 wt %, or from about 2.5 wt % to about 3.5 wt %, based on the weight of the carpet face yarn being treated (o.w.f.), and the optional fluorocarbon preferably can be added-on to the carpet face as active solids in an amount of from about 0.05 wt % to about 0.25 wt %, or about 0.1 wt % to about 0.2 wt %, or from about 0.125 wt % to about 0.175 wt %, or from about 0.14 wt % to about 0.16 wt %, based on the weight of the carpet face yarn being treated (o.w.f.). The dyed yarns, such as the differentially dyed yarns, have at least about 90% (by weight), or at least about 95%, of original dyed-in color of the yarns prior to combination with the bleach resistant stainblocker composition. The treated pile surface of the carpet can have a stain resistance of 8 or higher, or 9 or higher, on the AATCC Red 40 Stain Scale. The treated pile surface of the carpet can have a stain resistance of 2 or higher, or 3 or higher, or 4 or higher, on the AATCC Gray Scale for mustard and betadine. The treated pile surface of the carpet can have at least about 50% greater, or at least about 100% greater, retention of original color with respect to fade resistance to household bleach at 100%, 20%, and 10% concentrations, as compared an untreated carpet (% color retention based on visual inspection of shade depth difference based on shade comparison/matching), as accepted in the carpet industry.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the embodiments of the present invention and together with the description, serve to explain the principles of the present invention.

### BRIEF DESCRIPTION OF THE DRAWINGS

FIG. 1 shows a process flow diagram for conducting a method on an extruder tile line of a modular carpet system for production of carpet tiles including imparting stain and bleach resistance to dyed yarns of the carpet pile surface in accordance with an option of the present invention.

FIG. 2 is a side view of a carpet pile surface structure in accordance with an option of the present invention.

FIG. 3 shows a foam applicator station for use in methods for imparting stain and bleach resistance to dyed yarns of a carpet pile surface in accordance with an option of the present invention.

### DETAILED DESCRIPTION OF THE PRESENT INVENTION

The present invention is generally directed to a method for applying a bleach resistant stainblocker composition to a textile surface of a carpet or other article, and particularly a textile surface comprised of dyed yarns, for instance, differentially dyed yarns. The differential dyed or “styling” yarns can include, for example, basic dyeable and/or acid dyeable yarns (e.g., “cat/acid” dyed yarns), which can be treated with a bleach resistant stainblocker composition in a low wet pickup, high solids add-on format without significant loss of color from the basic dyeable color. Prior methods of treating carpet dyed cat/acid yarns have generally been unsuccessful due to the color change affects encountered at low pH and relatively high (greater than 100%) wet-add on techniques used for stainblocker application. In the present invention, there is minimal if any change in color due at least in part to the low wet pickup, steaming after a preferred low wet pickup foam treatment, and preferably no rinsing. Also, the performance of the bleach resistance stainblocker treatment of the present method is approximately the same as results obtained using a bleach resistant stainblocker composition applied in Beck after-treatment on carpet made with all acid dyeable yarns.

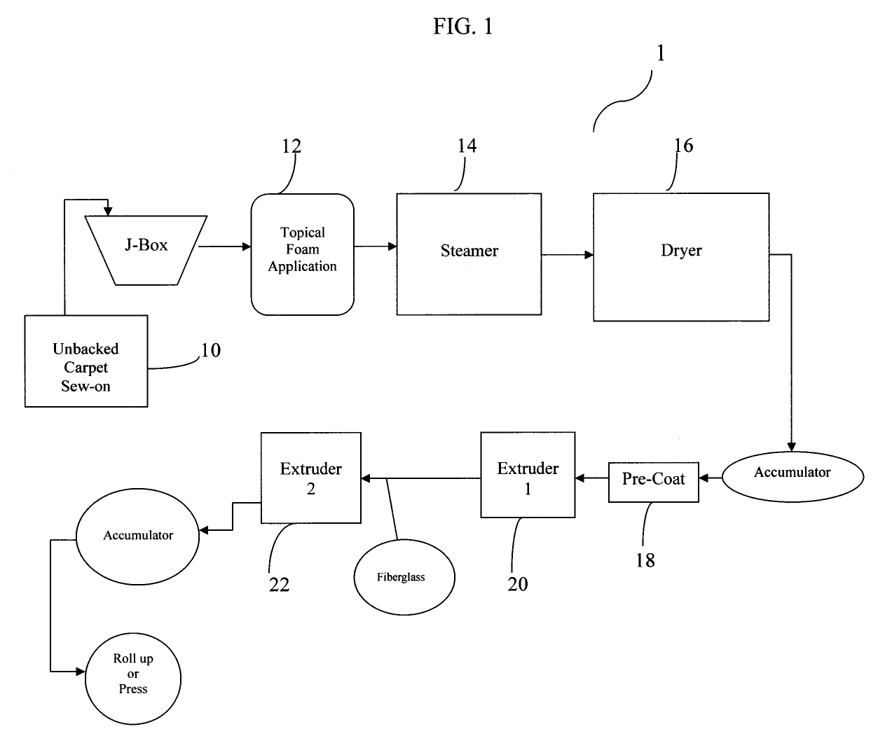

General Method and Process Layout. Referring to FIG. 1, an extruder tile line 1 of a modular carpet system is illustrated for conducting a method of the present invention in which an unbacked dyed carpet 10 is advanced to topical foam applicator 12 at which a bleach resistant stainblocker composition is applied to a pile surface of the unbacked carpet (or a backed carpet). The foam coated carpet workpiece can then be fed to a steamer 14, and then on to dryer 16, before a secondary backing (if not present already) is formed on the side of the carpet workpiece opposite to the pile surface, such as illustrated here as a multilayered backing formed using precoat station 18 and extruders 20 and 22. Although not required for the invention, several accumulator stations and a J-box (i.e., a J-shaped temporary holding or collecting area), which each can have a conventional design and mode of use, are also shown in FIG. 1.

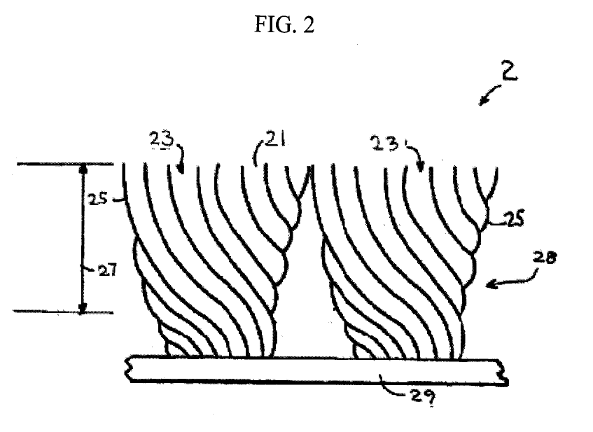

Carpet Yarns and Carpets. Referring to FIG. 2, the treated carpet product 2 has textile surface 21 that can be defined by a plurality of upstanding pile elements 23, and the pile elements 23 generally extend above a backing 29. The carpet may be any type, such as a full broadloom size, or (once the backing is applied) may be cut into the form of “carpet tiles” (not shown). As is appreciated by those in the art, “carpet tiles” are, in the typical case, generally discrete square pieces of carpet. The dimensions may be on the order of about 30-40 cm to about 30-40 cm, or other dimensions. Of course, tiles may take other shapes and exhibit any desired range of sizes. As the result of treatment of the carpet 2 (in either broadloom or tile form), at least a portion of the depth 27 or height of each pile element 23 has an exterior coating 25 of a bleach resistant stainblocker composition thereon. In practice the coated bleach resistant stainblocker composition 25 would typically be, but not necessarily always, visually transparent on the surfaces of the pile elements 23. For purposes of illustration, the coating 25 is represented by relatively bold lines on the contours of the pile elements 23. The upstanding pile elements 23 collectively form a pile surface 28 on one side of the carpet workpiece 2. Alternative forms of carpet structures also can lie within the contemplation of the invention. The pile elements 23 defining the textile surface of the pile surface can be either cut pile (as shown in FIG. 2) or loop pile (not shown), or any combination of cut, loop, and sheared product face construction.

The pile elements 23 of carpet workpiece 2 may be produced by any suitable known carpet forming process, such as tufting, weaving or knitting. In the case of a differentially dyed pile surface, each pile element 23, however produced, may be comprised of the same or different proportions of acid dyed yarns and cat dyed yarns. Alternatively, each pile element 23 can comprise a combination of both acid dyed yarns and/or cat dyed yarns.

The pile elements 23 can be formed of one or more of a variety of types of fibers and carpet yarns formed from fibers. Typically, the carpet yarn comprises an extruded synthetic polymer, such as nylon, polyester, polypropylene, or a combination thereof. Alternatively, the carpet yarn may be made from natural fibers, such as wool or cotton, or a combination of natural fibers and synthetic fibers. The carpet yarn can comprise, either in whole or in part, extruded fibers of nylon 6, nylon 6,6, or other polyamide chemical structures.

In the pile elements 23 formed of colored yarns, the color typically results from a dye treatment or from a melt extrusion process (i.e., dyes or pigments are incorporated into the fiber during an extrusion process). The extruded fibers may be made into yarn by various conventional means. Desirably, the yarn is a bulk continuous filament yarn or a staple spun yarn. Desirably, the yarn is not pre-treated with a fluorochemical by the yarn manufacturer, although fibers that have been pre-treated with a fluorochemical by the fiber manufacturer may be useful in the present invention.

The pile elements 23 may be formed in such a way that each pile element 23 includes both a nylon yarn dyeable by an acid dyestuff and/or a nylon yarn dyeable by a cationic dyestuff. Alternatively, the pile elements 23 may be formed such that at least some of the pile elements 23 are formed from a nylon yarn dyed by an acid dyestuff and/or at least others of the pile elements 23 are formed from a nylon yarn dyed by a cationic dyestuff.

The backing 29 for the carpet 2 may be formed using convenient materials or combinations of materials conventionally used for backing carpets. The backing 29 can comprise a single or multi-layered structure. For example, backing 29 can optionally comprise a precoat applied to the backing side, and one or more extruded backing portions, such as comprising a synthetic latex/chalk filler compound, applied upon the precoat.

Bleach resistant stainblocker composition. The bleach resistant stainblocker composition used in methods of the present invention can be a foamed mixture of a stainblocker and a fluorocarbon in an aqueous carrier or a foamed stainblocker without fluorocarbon in an aqueous carrier. The bleach resistant stainblocker composition can combine, in an aqueous carrier, a stainblocker of a polymeric type that has inherent bleach and stain resistant properties, and optionally a fluorocarbon that has a repellent type fluorocarbon, which imparts oil, water, and soil resistant properties to the carpet. Additional details on the components of the bleach resistant stainblocker composition are as follows. The bleach resistant stainblocker composition can comprise from about 25 wt % to about 85 wt % total water (moisture from all coating composition sources), and from about 75 wt % to about 15 wt % total solids (all coating composition sources) wherein the solids can comprise bleach resistant stainblocker and optionally oil-water-soil-resistant fluorocarbon. The solids content of the stainblocker composition preferably can comprise about 100 wt % or less, or from about 99 wt % to about 91 wt % solids of bleach resistant stainblocker and from 0 wt % to about 9 wt % (or from about 1 wt % to 9 wt %) solids of oil-water-soil-resistant fluorocarbon, or from about 97 wt % to about 93 wt % solids of bleach resistant stainblocker and from about 3 wt % to about 7 wt % solids of oil-water-soil-resistant fluorocarbon, all weight percentages based on total solids. The proportions of use of the bleach resistant stainblocker and fluorocarbon (if present) in the stainblocker composition preferably can be, for example, about 18:1 to about 22:1, respectively, on a solids:solids (w:w) basis. Where the bleach resistant stainblocker composition is foamed, the mass (weight) of air or gas in the foam composition is relatively small, and can be disregarded in the formulations given herein by weight percentages. More than one type of bleach resistant stainblocker and/or fluorocarbon can be present. Multiple applications of the same or different stainblocker compositions can be used.

Aqueous Carrier. The bleach resistant stainblocker compositions of the present invention can comprise water as a primary solvent or carrier. Soft or hard water may be used in the present invention, although soft water is more desirable. As used herein, the term “soft water” refers to water containing less than about 60 ppm of calcium carbonate. As used herein, the term “hard water” refers to water containing more than about 60 ppm of calcium carbonate, while “very hard water” refers to water containing more than about 180 ppm of calcium carbonate. The treating compositions of the present invention may be formed using water available from any municipal water-treatment facility. The aqueous stainblocker treating compositions of the present invention can comprise about 25 wt % to about 85 wt %, water based on a total weight of the bleach resistant stainblocker composition.

Bleach Resistance Stainblocker Agent. The bleach resistant stainblocker preferably comprises at least one polymer of a sulfonated lipid compound. The sulfonated lipid compound(s) preferably includes a carbon chain length of at least C₁₀ (e.g., C₁₀-C₁₀₀, C₂₀-C₂₀₀, C₃₀-C₇₀). Suitable sulfonated lipid compounds include one or more sulfonated triglycerides. Suitable sulfonated triglycerides can be provided as sulfonated marine oils, such as, for example, sulfonated menhaden oil, and the like. Sulfonated fatty acids also can be used, such as sulfonated oleic acid. Sulfonation methods suitable for functionalizing unsaturated carbon chains with a sulfonate group are known, which can be applied. A lipid compound can, for example, be sulfonated by addition of —SO₃H or —SO₃⁻ at an ethylenic double bond of a fatty acid chain of the compound.

The bleach resistant stainblocker can be sourced individually or in combination with one or more other coating additives such as a fluorocarbon. A source of a polymer of sulfonated triglyceride was obtained by the investigators from Phoenix Chemical Company (Calhoun, Ga.), which was referenced as PHOENIX CAP-107. The formulation also contained another active ingredient, a fluorocarbon. Exemplary use of amounts of the bleach resistant stainblocker are described herein, such as in Table I below.

The pH of the bleach resistant stainblocker composition that contains these stainblockers can be adjusted, for example, to a pH of from about 3.5 to about 6.5, or from about 4 to about 5, for the coatings used in the methods of the present invention. If the pH of the composition is too high, the acid dyes can migrate, which can contribute to color loss in the yarns from the stainblocker treatment. The pH of the aqueous stainblocker treatment composition may be adjusted, as applicable, by suitable acid or base materials, such as acetic acid, citric acid, sulfamic acid, phosphoric acid, urea sulfate, and the like.

Fluorochemical. The bleach resistant stainblocker compositions of the present invention can contain at least one oil-water-soil-resistant fluorochemical compound. The fluorochemical compounds suitable for use in the present invention can be fluorochemical compounds that can produce a stable solution or dispersion when incorporated into the coating foams described herein. The fluorochemical compound can be an anionic, cationic, or nonionic fluorochemical. Further, the fluorochemical compound may be either a telomer type or an electrochemically fluorinated fluorochemical. Suitable fluorochemical compounds and compositions include, but are not limited to, PHOENIX EFC-5U, from Phoenix Chemical Company (Calhoun, Ga.). The PHOENIX EFC-5U composition contains 15 wt % active solids of an anionic six-carbon fluorinated urethane. This fluorocarbon composition contains approximately 5 wt % fluorine overall, and the 15 wt % active fluorocarbon content of the composition is 33.3 wt % fluorine. Other variations on this fluorocarbon composition and other fluorocarbons can be used where the desired stain and bleach resistance is obtained.

Other or additional fluorocarbons can be, for example, DAIKIN 472A, Unidyne 2211, both of which are commercially available from Daikin America, Inc. (Orangeburg, N.Y.); PM 1396 and PM 1451, both of which are commercially available from 3M Specialty Chemicals Division (St. Paul, Minn.); N-119, Zonyl 9997, A402, A403, all of which are commercially available through Invista S.a.r.l (Wichita, Kans.), Capstone RCP, Zonyl 9933, both which are commercially available from Dupont (Wilmington, Del.) Nuva N series which is commercially available from Clariant Corporation (Charlotte, N.C.), Repearl F8025 and AGE-061 from MIC Specialty Chemicals, Inc. (Iselin, N.J.). Arrotex F-5 from ArrowStar, LLC (Dalton, Ga.). The amount of fluorochemical compound in the aqueous treating compositions of the present invention may vary depending on a number of factors including, but not limited to, the type of yarn and the level of fluorochemical desired on the yarn.

Foaming agent. As indicated, the bleach resistant stainblocker composition preferably can be applied to the carpet as a foam. At the time of application to a carpet pile as a foam, the bleach resistant stainblocker composition also contains air and/or other gas. The quantity of gas introduced to the composition preferably is enough to provide a foam form of the composition that has controlled or limited penetration into the pile surface after application thereto and permits add-on of the active agents, i.e., the bleach resistance stainblocker and fluorocarbon, in effective amounts thereof. Increasing the gas content in the foams provides lighter foams that tend to penetrate less easily into a carpet pile surface, and decreasing the gas content in the foams tends to provide heavier foams that penetrate more easily into the carpet pile surface.

Foaming can be accomplished with material, such as air or gas-filled glass, ceramic and/or resin microbubbles or hollow microspheres or solid spheres or other similar material present, for instance, in a column or other holding device.

Other Additives. The bleach resistant stainblocker composition can optionally contain one or more other additives to the extent they do not impair the performance of the bleach resistant stainblocker, fluorocarbon, and/or foaming agent combination. Other additives can include, for example, at least a surfactant, such as a nonionic surfactant, emulsifier, or combinations thereof, buffers, diluents, and the like.

Exemplary Treating Formulations. The above-indicated sulfonated triglyceride stainblocker and the fluorocarbon can be individually supplied to the bleach resistant stainblocker composition or can be jointly sourced from a common composition. A general exemplary formulation for the bleach resistant stainblocker composition used in methods and carpets of the present invention is given in Table I. Other formulations can be used.

TABLE I
Bleach Resistant Stainblocker Composition

| | | | | active solids |
|---|---|---|---|---|
| | Component | wt % active | | component/total |
| | source wt % | solids in | | active solids |
| | of | component | active solids wt % | composition, % |
| Component | composition | source | in composition | (w/w) |
| (a) polymer of | 60-72% | ~30% | 18-22% | 97-93% |
| sulfonated triglyceride | | | | |
| source | | | | |
| (b) anionic fluorinated | 4-10% | ~15% | 0.6-1.5% | 3-7% |
| urethane source | | | | |
| (c) (additional) water | 20-32% | 0% | 0% | 0% |

A non-limiting example of the bleach resistant stainblocker composition comprises, for example, 66.67 wt % triglyceride source (for example, a 30 wt % solids content source of polymer of sulfonated triglyceride), 6.67 wt % fluorocarbon source (for example, a 15 wt % solids content source of anionic 6-carbon fluorinated urethane), and 26.67 wt % (additional) water.

Method of Making the Treating Composition. The bleach resistant stainblocker composition can be prepared by combining the bleach resistance stainblocker, the fluorocarbon, and water (in any order or combination) with sufficient mixing to provide a uniform mixture thereof. The bleach resistant stainblocker composition preferably is worked into foam form before application to a carpet pile surface. A conventional foam blender or dynamic foamer can be used which injects air into a liquid composition containing the bleach resistance stainblocker, fluorocarbon, and water components with agitation or blending effective to foam up the chemistry. A suitable blow ratio (air:liquid) preferably can be from about 5 to about 80, or from about 5 to about 30, or from about 10 to about 20, or other suitable blow ratios with respect to considerations such as the pile penetration of the foam coating, active solids add-on parameters, and/or foam puddle height, as described herein.

Other forms of the bleach resistant stainblocker composition also may be used that allow for low wet pickup and controlled penetration into the depth of the carpet pile surface.

Method of Treating Carpet Yarns and Carpets. The present invention is further directed to methods of treating carpet yarns and carpets by contacting the carpet yarns and/or carpets with at least one of the above described aqueous treating compositions. To produce carpet tiles treated with a bleach resistant stainblocker composition, a broadloom carpet can be treated with a bleach resistant stainblocker composition in a manner exemplified herein, and after a backing is applied, the broadloom carpet can be cut into pieces of the desired size to form carpet tiles. Alternatively, the carpet tiles can be pre-cut and treated with the bleach resistant stainblocker composition as discrete tiles. The treatment process can be conducted continuously or batchwise.

A system for application of the bleach resistant stainblocker composition, such as illustrated in FIG. 1, should be configured in relation to line speeds and carpet widths, and characteristics of the bleach resistant stainblocker composition to deliver the composition at rates effective to achieve the preferred application amounts described herein. The carpet yarn preferably is coated with the aqueous treating composition in foam form. The carpet can be advanced under a foam applicator at a coating station. Preferably the foamed composition is applied directly onto the pile surface of the carpet.

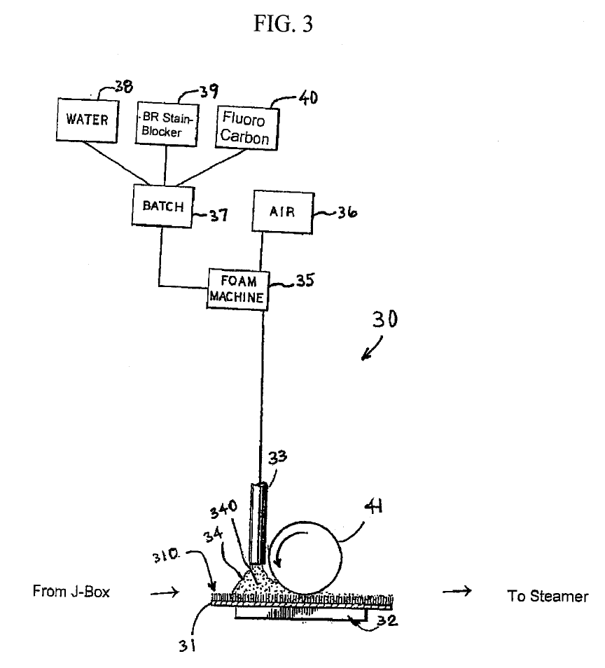

Referring to FIG. 3, a foam applicator station 30 is illustrated, which can be used to apply the foam composition to the pile surface of a carpet. A length of carpet to be treated with a foamed bleach resistant stainblocker composition is generally represented by the reference numeral 31 and is conveyed along a predetermined path by a conventional carpet conveying apparatus (not shown). Carpet support member 32 is positioned beneath carpet 31 with a foam applicator 33 supported above the pile surface 310 of carpet 31. A foam 34 containing bleach resistance stainblocker, fluorocarbon, and water, is supplied to foam applicator 33 by a conventional foam machine 35. Foam machine 35 is connected to an air supply 36, which is used in developing a foam. Foam machine 35 is supplied with a mixture of materials from batch 37, which contains a mixture of predetermined amounts of water 38, bleach resistance stainblocker 39, and fluorocarbon 40. These batch materials can be supplied in a preformulated form or can be batched on site. As indicated, the carpet 31 can be advanced from the J-Box (e.g., see FIG. 1) to the foam applicator station 30, and, from there, to the steamer (e.g., see FIG. 1). A press roller 41 is positioned to sit on the carpet adjacent the foam applicator 33 along the path of movement of the carpet 31. A puddle 340 of the foam 34 is maintained at the foam application or rear side of the press roller 41, which is sufficient to cover the width, preferably 100% of the width, of the carpet 31, without flowing over the roll 41. The pressure roller can be positioned to provide a nip with respect to the pile surface, wherein the penetration depth of the foam coating into the pile surface can be controlled or adjusted. To assist confinement of the puddle of foam 340 to the width of the carpet, edge dams or other lateral upstanding confining members (not shown) can be positioned on opposite lateral sides of the conveyor at the rear side of the pressure roller 41 where the foam puddle 340 is provided. Other foam applicator arrangements also can be used. For example, a doctoring blade (not shown) extending across the width of the carpet, and behind which a puddle of foam could be maintained, may be used instead of the pressure roller 34. The foam also may be metered to a slotted applicator extending across the width of the carpet. Additional pressure rolls may also be used to facilitate penetration of the foam into the carpet pile.

The foam can be applied to the pile surface at from about 100° F. to about 120° F., or other temperatures below or above these temperatures. The foam coating can penetrate the textile surface, such as to a depth of no more than about 0.33 inch, or no more than about 0.25 inch, or from about 0.1 to about 0.25 inch. As an option, the foam coating does not penetrate through the entire depth or height of the pile, and instead a partial penetration can be achieved. The application step can comprise coating no more than about 50 wt %, or no more than about 25 wt %, or no more than about 20 wt %, or no more than about 15 wt %, or no more than about 10 wt %, wet pickup of the bleach resistant stainblocker composition to the textile surface, based on the weight of carpet face yarn (o.w.f.). In a preferred embodiment, the application step can comprise coating about 5 wt % to about 20 wt % wet pickup of the bleach resistant stainblocker composition on the textile surface, based on the weight of carpet face yarn (o.w.f.). For a 15 wt % wet add-on application rate, the 15% wet add-on of the bleach resistant stain blocker composition can be composed as 10 wt % of the bleach resistant stain blocker source, 1 wt % of the fluorocarbon source, and 4 wt % water (i.e., 10%+1%+4%=15% total), all based on weight of carpet face yarn (o.w.f.). These low wet pick-up amounts reflect that the use of foam application of the bleach resistant stainblocker composition used in the present invention facilitates wet pickup control.

The foam coated carpet can be next steamed. The steaming step can comprise contacting the textile surface with saturated steam, for instance, under atmospheric pressure. The steaming step can be for any suitable time, for instance, to allow for better exhaustion and/or fixation of the stainblocker and/or co-additive chemicals to the pile elements. The steaming time can be, for instance, up to about 2 minutes, or about 1 to about 2 minutes, or other times above or below these ranges or within these ranges. The use of steam treatment after applying the bleach resistant stainblocker composition to the pile surface allows for better exhaustion or fixation of the stainblocker and co-additive chemicals to the pile elements. Steaming can accomplish these purposes.

After steaming, the carpet is dried. Preferably, the carpet is dried to a moisture content of no more than 5 wt % (e.g., 0-5 wt % moisture content). The drying step can comprise exposing the steamed article to dry heat (e.g., hot air). Drying of the treated carpet, after steaming, can occur at any temperature which dries the carpet to the desired moisture content. The drying can be conducted at about 225° F. to 275° F. and can be for a time period of from about 1 minute to about 3 minutes. Other times and/or temperatures above or below these ranges can be used, such as greater than 275° F., or less than 225° F. for any time period, such as 10 seconds or more. A conventional flow-through drying oven can be used, or other suitable drying means. The steaming and drying steps can be performed sequentially and/or free of any intermediate rinsing step. Rinsing is not required between the steaming and drying steps. Also, conventional hydroextraction operations, such as vacuum removal of water content from the carpet, is not required between the steaming and drying steps nor anytime after the application of the bleach resistant stainblocker composition.

Carpet Products. Products of the method are bleach and stain resistant dyed fibers, such as differentially dyed fibers, and carpet material containing them. The dried carpet article preferably can comprise from 0.1 wt % to about 6 wt %, or from about 1 wt % to about 5 wt %, or about 2 wt % to about 4 wt %, or from about 2.5 wt % to about 3.5 wt %, total solids add-on of the bleach resistant stainblocker composition, based on the weight of the carpet face yarn being treated (o.w.f.). The bleach resistant stainblocker, such as at least one polymer of a sulfonated triglyceride, can be added-on to the carpet face as active solids in an amount of from about 0.1 wt % to about 5 wt %, or about 1 wt % to about 4.5 wt %, or from about 2 wt % to about 4 wt %, or from about 2.5 wt % to about 3.5 wt %, based on the weight of the carpet face yarn being treated (o.w.f.). The fluorocarbon (if present), such as at least one anionic fluorinated urethane, can be added-on to the carpet face as active solids in an amount of from about 0.05 wt % to about 0.25 wt %, or about 0.1 wt % to about 0.2 wt %, or from about 0.125 wt % to about 0.175 wt %, or from about 0.14 wt % to about 0.16 wt %, based on the weight of the carpet face yarn being treated (o.w.f.). The amount of fluorocarbon usage preferably provides from about 100 parts per million (ppm) to about 1,500 ppm, or from about 300 ppm to about 800 ppm, or from about 400 to about 600 ppm fluorine in the treated carpet pile.

The dyed yarns can comprise at least one type (such as 1, 2, or 3 or more acid dyed yarns) of yarn dyed by an acid dyestuff and/or at least one type (such as 1, 2, or 3 or more cat dyed yarns) of yarn dyed by a cationic dyestuff. The dyed yarns can comprise nylon yarns and/or other types. The textile surface of the carpet article can be coated with the bleach resistant stainblocker composition such that the stainblocker is exhausted onto the yarns sufficient that that the textile surface preferably has a stain resistance of 8 or higher, or 9 or higher, on the AATCC Red 40 Stain Scale. The treated pile surface of the carpet also preferably can have a stain resistance of 2 or higher, or 3 or higher, or 4 or higher, on the AATCC Gray Scale for mustard and betadine. The treated pile surface of the carpet also can have at least about 50% greater, or at least about 100% greater, retention of original color, with respect to fade resistance to household bleach at 100% and 20% concentrations thereof, as compared an untreated carpet.

Stain And Bleach Standard Test Methods. The following test methods were used to measure stain resistance of carpet samples made according to the method of the present invention.

Red Stain Resistance Standard Test. Soft Drink Stain Resistance Standard Test (Standardized AATCC Test Method 175-1991: Red 40 Stain Rating Scale). This impact tester method simulates a “household accident” with a spill dropped from table height onto a carpet. The staining agent is a ninety (90) gram per thousand (1000) cc water solution of cherry-flavored, sugar-sweetened KOOL-AID® soft drink (Kraft Foods, Northfield, Ill.). The solution is permitted to reach room temperature (22±2° C.) before use. An alternative staining agent is red wine. As the equipment uses, a specially designed impact tester is used to apply the staining agent to the specimens under test. The impact tester comprises a cylinder (of plastic or glass) that is 28 cm high with a 6.5 cm inside diameter. A massive piston nine (9) cm in length weighing four hundred (400) grams is received on the inside of the cylinder. The piston is made from a plastic material (PVC or PTFE). The piston is vertically movable within the cylinder by a bolt fitted to the piston. The bolt projects through a four (4) mm vertical slot in the cylinder. A small (seven (7) mm diameter) hole is drilled through the cylinder two cm from the bottom for injecting staining agent. As the testing procedure, test samples, measuring ten (10) cm square, are cut from each pile surface structure under test. The impact tester is centered on each sample and the plastic piston lifted and fixed in position by the bolt in the slot. Using a syringe twenty (20) cc of the staining agent is injected through the small hole over the surface of the sample. The plastic piston is released and drops freely onto the carpet sample. The impact corresponds to the impact of a cup of liquid falling from the table height [eighty (80) cm]. The impact tester is removed and the sample is left, undisturbed, in a horizontal position for twenty-four (24±4) hours. Without damaging the pile, the sample is rinsed thoroughly with tap water at about twenty degrees Celsius (20° C.), centrifuged to remove any excess water and dried in a forced air oven at maximum of seventy-five degrees Celsius (75° C.). Each sample is evaluated for staining, using the AATCC Red 40 Stain Scale. According to this scale stains are rated on a scale of 1 to 10, with “1” designating heavy staining and “10” designating no staining. A rating of “10” is best. Higher scores are better than lower scores.

Mustard Resistance Standard Test. The test was conducted using the AATCC Gray Scale. The mustard can be, for example, FRENCH's® Classic Yellow Mustard (Parsippany, N.J.). The resistance of the carpet face to staining is rated on a scale of 1 to 5, with “1” designating severe staining and “5” designating no stain. A rating of “5” is best. Higher scores are better than lower scores.

Betadine Resistance Standard Test. The test also was conducted using the AATCC Gray Scale with a test method similar to that used for the Mustard Resistance Standard Test with betadine used instead of mustard. Betadine (Purdue Pharma, LP., Stamford, Conn.) refers to a 10% povidone-iodine solution.

Bleach Resistance Standard Test. The test was conducted using household bleach (approx. 6% sodium hypochlorite) at 100%, 20%, and 10% weight concentrations thereof. The % retention of original color was determined by wetting an approximately 2 to 3 inch diameter circular spot on the carpet pile with 10-22 mL of the bleach solution, and, after 24 hours, the stained area is rinsed thoroughly with tap water, extracted, then neutralized with 30 ml of a 10% solution of Sodium Metabisulfite, rinsed again with tap water, extracted, air dried an rated after complete drying (usually overnight). The stain is then rated by an experienced shade matcher comparing the stained area with the surrounding regions of the carpet pile to determine the visually-perceived percentage of color retention in the treated area (and thus also the percentage of fading or color loss as 100-color retention %). The percentage color retention is an indicator of fade resistance. Higher % retention of original color is better than a lower % color retention. The “neutralization” portion of this test is done to completely stop “bleaching” due to any bleach remaining after the 1^{st} rinse with tap water. Measurement of color retention is done visually due to the difficulty of measurement of multicolored materials.

Accordingly, as a summary, the present invention relates to the following aspects/embodiments/features in any order or combination:

1. A method for treating an article having a textile surface formed of dyed yarns, such as differentially dyed yarns, with a bleach resistant stainblocker composition, comprising:
applying an aqueous bleach resistant stainblocker composition to said textile surface at a wet pickup of bleach resistant stainblocker composition of no greater than about 50 wt % based on weight of carpet face yarn (o.w.f.), to provide a coated article; steaming said coated article to provide a steamed article; drying said steamed article to provide a dried article, wherein the dried article comprises at least about 0.1 wt % solids add-on of said bleach resistant stainblocker composition based on weight of carpet face yarn (o.w.f.).

2. The method of any preceding or following embodiment/feature/aspect wherein the bleach resistant stainblocker composition is added to the textile surface in an amount effective that the textile surface has a stain resistance of 8 or higher on the AATCC Red 40 Stain Scale.

3. The method of any preceding or following embodiment/feature/aspect, wherein the bleach resistant stainblocker composition has a pH of from about 3.5 to about 6.5.

4. The method of any preceding or following embodiment/feature/aspect, further comprising selecting the article as an unbacked carpet and said textile surface comprises a pile surface comprising said dyed yarns, such as differentially dyed yarns.

5. The method of any preceding or following embodiment/feature/aspect, further comprising selecting the dyed yarns, such as differentially dyed yarns, as comprising at least one type (or 2 or 3 types) of yarn dyed by an acid dyestuff and/or at least one type (or 2 or 3 types) of yarn dyed by a cationic dyestuff.

6. The method of any preceding or following embodiment/feature/aspect, wherein said dyed yarns, such as differentially dyed yarns, comprise nylon yarns.

7. The method of any preceding or following embodiment/feature/aspect, wherein said applying comprises coating no more than about 20 wt % wet pickup of said bleach resistant stainblocker composition to said textile surface.

8. The method of any preceding or following embodiment/feature/aspect, wherein said applying comprises coating from about 5 to about 20 wt % wet pickup of said bleach resistant stainblocker composition to said textile surface.

9. The method of any preceding or following embodiment/feature/aspect, wherein said dried article comprising from about 1 wt % to about 5 wt % solids add-on of said bleach resistant stainblocker composition, based on weight of carpet face yarn (o.w.f.).

10. The method of any preceding or following embodiment/feature/aspect, wherein the bleach resistant stainblocker composition comprises at least one polymer of sulfonated triglyceride, optionally at least one anionic fluorinated urethane, and water.

11. The method of any preceding or following embodiment/feature/aspect, wherein the sulfonated triglyceride and/or other stainblocker polymer is added-on to the carpet face as active solids in an amount of from about 0.1 wt % to about 5 wt %, and the optional anionic fluorinated urethane (and/or other fluorocarbon) is added-on to the carpet face as active solids in an amount from about 0.05 wt % to about 0.25 wt %, based on weight of carpet face yarn (o.w.f.).

12. The method of any preceding or following embodiment/feature/aspect, wherein the steaming and drying steps are performed sequentially and free of any intermediate rinsing step.

13. The method of any preceding or following embodiment/feature/aspect, wherein said applying comprises topically applying said composition as foam on the textile surface.

14. The method of any preceding or following embodiment/feature/aspect, wherein the steaming step comprises contacting the textile surface with steam under atmospheric pressure for about 1 to about 2 minutes.

15. The method of any preceding or following embodiment/feature/aspect, wherein said drying step comprises drying the steamed article at from about 225° F. to about 275° F. for a time period of from about 1 minute to about 3 minutes.

16. The method of any preceding or following embodiment/feature/aspect, further comprising forming a secondary backing on a side of the article opposite to the textile surface prior to and/or after said applying step.

17. The method of any preceding or following embodiment/feature/aspect, wherein said article is supplied to said applying step as a continuous carpet material.

18. The method of any preceding or following embodiment/feature/aspect, wherein said bleach resistant stainblocker composition comprising from about 25 wt % to about 85 wt % total water, and from about 75 wt % to about 15 wt % total solids comprising bleach resistant stainblocker and optionally oil-water-soil-resistant fluorocarbon, wherein said solids content comprises from about 100 wt % or less, or from 99 wt % to about 91 wt % solids bleach resistant stainblocker and from 0 wt % to about 9 wt % solids (or about 1 wt % to 9 wt %) fluorocarbon, all weight percentages based on total composition solids.

19. The method of any preceding or following embodiment/feature/aspect, wherein the dyed yarns in the dried article maintain at least about 90% of original color possessed before the applying step.

20. Stain and bleach resistant dyed yarns, such as differentially dyed yarns, for a carpet pile, comprising dyed yarns, such as differentially dyed yarns, and from about 0.1 wt % to about 6 wt % add-on of bleach resistant stainblocker composition solids based on weight of carpet face yarn (o.w.f.), wherein the bleach resistant stainblocker composition comprises 100 wt % or less, or from about 99 wt % to about 91% wt % active solids bleach resistant stainblocker and 0 wt % to about 9 wt % (e.g., 1 wt % to 9 wt %) active solids oil-water-soil-resistant fluorocarbon, all weight percentages based on total composition solids.

21. The yarns of any preceding or following embodiment/feature/aspect, wherein the dyed yarns, such as differentially dyed yarns, comprising at least one type of yarn dyed by an acid dyestuff and/or at least one other type of yarn dyed by a cationic dyestuff.

22. The yarns of any preceding or following embodiment/feature/aspect, wherein said dyed yarns, such as differentially dyed yarns, comprise nylon yarns.

23. A carpet comprising the stain and bleach resistant dyed yarns, such as differentially dyed yarns, of any preceding or following embodiment/feature/aspect.

The present invention will be further clarified by the following examples, which are intended to be exemplary of the present invention.

### Examples

### Example 1

Carpets were treated with a foamed bleach resistant stainblocker composition to evaluate its affect on bleach and stain resistance of differentially dyed yarns in the carpets using a method of the present invention.

Carpet Construction. The carpets used in the example were made with the various face yarns and styles as noted below.

Where the example refers to “Carthage” style carpet, this is a 25 ounce/square yard (osy) unbacked loop pile carpet. The pile surface structure was a loop construction containing different filament yarn types. These yarns have approximately 25% dyeable yarns, and 75% solution dyed yarns. The yarns were type 66 nylon.

Where the example refers to “COLCM” style, MOBE color type carpet, this is a 32 ounce/square yard unbacked loop pile carpet. The pile surface structure was a loop construction containing different filament yarn types having deep acid dyeable and light acid dyeable yarns. The yarns were type 66 nylon. The fiber color was light silver.

Where the example refers to “LALAM'” style, CREO color type carpet, this is a 30 ounce/square yard unbacked multilevel cut and loop pile carpet. The pile surface structure was a multilevel cut and loop pile construction containing different filament yarn types having cationic and acid dyeabilities. The yarns were approximately 25% cationic dyeable yarn. The yarns were type 66 nylon. The fiber colors were a medium dark grey background, and rust colored cationic dyeable barber pole.

Methods Used in Examples. Lengths of each of the above-indicated carpet styles were treated with a foamed bleach resistant stainblocker composition on a production line substantially identical to the arrangements described herein with reference to FIGS. 1 and 3. A foamed bleach resistant stainblocker composition formulated with a sulfonated triglyceride, an anionic 6-carbon fluorinated urethane, and water, which was obtained from Phoenix Chemical Co. (Calhoun, Ga.). The composition is referenced as PHOENIX CAP-107. The PHOENIX CAP-107 mixture contents were 66.67 wt % triglyceride source (a polymer of sulfonated triglyceride source, 30 wt % solids), 6.67 wt % fluorocarbon source (an anionic 6-carbon fluorinated urethane source, 15 wt % solids), and 26.67 wt % water. The fluorocarbon source included in the stainblocker composition was composed of PHOENIX EFC-5U (Phoenix Chemical Co., Calhoun, Ga.). The bleach resistant stainblocker composition was used at a pH of approximately 4.5.

A trial was conducted using fresh Carthage, LALAM, and COLCM, with the following settings on the foamer control panel: 30 oz./yd², and a 15% wet pick up target. The carpet speed was 20 feet/minute, and the foam blender was set at 200 rpm.

During the trial, the equipment was operating on automatic mode, which delivers the chemical based on the carpet face weight and line speed flow, and controls the puddle size with air flow adjustments. The basis for the controlled air is a laser measurement of puddle size with a minimum of 6 inches, and a maximum of 12 inches. When the puddle measured less than 6 inches, then it will call for more air up using to 6:1 blow ratio increase. When the puddle is measured to more than 12 inches in diameter, then it will automatically reduce the air flow with the limit of a 6:1 blow ratio decrease. During this trial, a sample of foam was taken to measure the blow ratio, and the measure was approximately 30 to 1. During the end of the run, the Blow Ratio was adjusted, and 40 oz./yd² and the resultant measured Blow Ratio was 34:1. All three carpets had considerable pick-up of the coating, and were steamed for 2 minutes set at 200° F. and dried at 250° F. The control read out indicated that the actual wet pick up of the foamed bleach resistant stainblocker composition was ranging from 7.5 wt % to 9 wt %. Untreated portions of each carpet were held back and used as controls for comparative purposes in bleach and stain determinations. The carpets were sampled and tested for stain and bleach resistance with the results indicated below in Table II.

TABLE II

| | Carpet Style | | | | | |
|---|---|---|---|---|---|---|
| | Carthage | | COLCM-MOBE | | LALAM CREO | |
| Test | Un- | | Un- | | Un- | |
| Description | treated | Treated | treated | Treated | treated | Treated |
| 24 Hr. | 7 | 9.5 | 1 | 10 | 1 | 10 |
| KOOL-AID | | | | | | |
| 24 Hr. | 2 | 4.5 | 1 | 3 | 3 | 5 |
| Mustard | | | | | | |
| 24 Hr. | 3 | 4 | 1 | 2 | 2 | 4 |
| Betadine | | | | | | |
| 100% Bleach | 20 | 80 | 0 | 10 | 10 | 20 |
| 20% Bleach | 50 | 100 | 5 | 40 | 10 | 70 |
| 10% Bleach | 100 | 100 | 20 | 95 | 15 | 95 |
| Xenon | 4 | 4 | 3 | 3 | 3.5 | 3.5 |
| 60 SFU | | | | | | |
| Fluorine | — | 862 | — | 326 | — | 522 |
| ppm Avg. | | | | | | |

The results show that significantly improved bleach and stain resistance is imparted to differentially dyed yarns in carpet with the present invention. Enhanced bleach and stainblocking performance, as compared to an untreated control, was provided on all the styles of carpets, which were evaluated using a relatively low pick up rate of the treatment composition without a rinse, and with minimal steam time. Other trial work performed on the COLCM-MOBE and LALAM CREO carpets have shown the resistance to bleach on both fabrics attained approximately 75% of the resistance normally achieved in a Beck after-treatment using a standard chemistry.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present teachings will be apparent to those skilled in the art from consideration of the specification and practice of the present teachings disclosed herein. It is intended that the specification and examples be considered as exemplary only, with the true scope and spirit of the present invention being indicated by the following claims and equivalents thereof.

What is claimed is:

1. A method for treating an article having a textile surface formed of dyed yarns with a bleach resistant stainblocker composition, comprising:
applying an aqueous bleach resistant stainblocker composition to said textile surface at a wet pickup of bleach resistant stainblocker composition of no greater than about 50 wt % based on weight of carpet face yarn (o.w.f.), to provide a coated article; steaming said coated article to provide a steamed article; drying said steamed article to provide a dried article, wherein the dried article comprises at least about 0.1 wt % solids add-on of said bleach resistant stainblocker composition based on weight of carpet face yarn (o.w.f.).

2. The method of claim 1, wherein the dyed yarns are differentially dyed yarns.

3. The method of claim 1, wherein the bleach resistant stainblocker composition is added to the textile surface in an amount effective that the textile surface has a stain resistance of 8 or higher on the AATCC Red 40 Stain Scale.

4. The method of claim 1, wherein the bleach resistant stainblocker composition has a pH of from about 3.5 to about 6.5.

5. The method of claim 1 further comprising selecting the article as an unbacked carpet and said textile surface comprises a pile surface comprising said dyed yarns.

6. The method of claim 1, further comprising selecting the dyed yarns as comprising at least one type of yarn dyed by an acid dyestuff or at least one type of yarn dyed by a cationic dyestuff, or both.

7. The method of claim 1, wherein said dyed yarns comprise nylon yarns.

8. The method of claim 1, wherein said applying comprises coating no more than about 20 wt % wet pickup of said bleach resistant stainblocker composition to said textile surface.

9. The method of claim 1, wherein said applying comprises coating from about 5 to about 20 wt % wet pickup of said bleach resistant stainblocker composition to said textile surface.

10. The method of claim 1, wherein said dried article comprising from about 1 wt % to about 5 wt % solids add-on of said bleach resistant stainblocker composition, based on weight of carpet face yarn (o.w.f.).

11. The method of claim 1, wherein the bleach resistant stainblocker composition comprises at least one polymer of sulfonated triglyceride, at least one anionic fluorinated urethane, and water.

12. The method of claim 11, wherein the sulfonated triglyceride is added-on to the carpet face as active solids in an amount of from about 0.1 wt % to about 5 wt %, and the anionic fluorinated urethane is added-on to the carpet face as active solids in an amount from about 0.05 wt % to about 0.25 wt %, based on weight of carpet face yarn (o.w.f.).

13. The method of claim 1, wherein the steaming and drying steps are performed sequentially and free of any intermediate rinsing step.

14. The method of claim 1, wherein said applying comprises topically applying said composition as foam on the textile surface.

15. The method of claim 1, wherein the steaming step comprises contacting the textile surface with steam under atmospheric pressure for about 1 to about 2 minutes.

16. The method of claim 1, wherein said drying step comprises drying the steamed article at from about 225° F. to about 275° F. for a time period of from about 1 minute to about 3 minutes.

17. The method of claim 1, further comprising forming a secondary backing on a side of the article opposite to the textile surface prior to or after said applying step.

18. The method of claim 1, wherein said article is supplied to said applying step as a continuous carpet material.

19. The method of claim 1, wherein said bleach resistant stainblocker composition comprising from about 25 wt % to about 85 wt % total water, and from about 75 wt % to about 15 wt % total solids comprising bleach resistant stainblocker and oil-water-soil-resistant fluorocarbon, wherein said solids content comprises from about 99 wt % to about 91 wt % solids bleach resistant stainblocker and from about 1 wt % to about 9 wt % solids fluorocarbon, all weight percentages based on total composition solids.

20. The method of claim 1, wherein said bleach resistant stainblocker composition comprising from about 25 wt % to about 85 wt % total water, and from about 75 wt % to about 15 wt % total solids comprising bleach resistant stainblocker.

21. The method of claim 1, wherein the dyed yarns in the dried article maintain at least about 90% of original color possessed before the applying step.

22. Stain and bleach resistant dyed yarns for a carpet pile, comprising differentially dyed yarns and from about 0.1 wt % to about 6 wt % add-on of bleach resistant stainblocker composition solids based on weight of carpet face yarn (o.w.f.), wherein the bleach resistant stainblocker composition comprises about 100 wt % to about 91% wt % active solids bleach resistant stainblocker and 0 wt % to about 9 wt % active solids oil-water-soil-resistant fluorocarbon, all weight percentages based on total composition solids.

23. The yarns of claim 22, wherein the dyed yarns comprising at least one type of yarn dyed by an acid dyestuff and/or at least one other type of yarn dyed by a cationic dyestuff.

24. The yarns of claim 22, wherein said dyed yarns comprise nylon yarns.

25. A carpet comprising the stain and bleach resistant dyed yarns of claim 22.
